(19) United States
(12) Patent Application Publication
(10) Pub. No.: US 2015/0003463 A1
(43) Pub. Date: Jan. 1, 2015

(54) Multiprotocol Label Switching Transport for Supporting a Very Large Number of Virtual Private Networks

(71) Applicant: Futurewei Technologies, Inc., Plano, TX (US)

(72) Inventors: Renwei Li, Fremont, CA (US); Katherine Zhao, San Jose, CA (US); Ming Li, Cupertino, CA (US)

(21) Appl. No.: 14/317,818

(22) Filed: Jun. 27, 2014

Related U.S. Application Data
(60) Provisional application No. 61/841,110, filed on Jun. 28, 2013.

(51) Int. Cl. H04L 12/723

(52) U.S. Cl. CPC H04L 45/507
USPC 370/395.53

(57) ABSTRACT

A network node for forwarding a data packet to a virtual network. The network node may maintain a table comprising one-to-one mapping information between one or more virtual private network (VPN) labels and one or more identifying labels for a destination virtual network. The network node may receive a data packet from a Multiprotocol Label Switching (MPLS) network. The data packet may comprise one or more VPN labels, at least one of which may be a MPLS Big Label Value that supports one-to-one mapping for more than one million destination virtual network addresses. The MPLS Big Label Value may comprise a destination virtual network address. The network element may map the one or more VPN labels to corresponding identifying labels for the destination virtual network according to the table, and forward the data packet to the destination virtual network.

### CROSS-REFERENCE TO RELATED APPLICATIONS

The present application claims priority to U.S. Provisional Patent Application 61/841,110, filed on Jun. 28, 2013 by Renwei Li et al., and entitled “Multiprotocol Label Switching Transport for Supporting a Very Large Number of Virtual Private Networks,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Increasing consumer and business adoption of cloud computing and storage has pushed data centers to support an ever-increasing number of customers. To do so, the data centers create virtual networks for these customers using virtualization encapsulation methods and protocols, such as Virtual Extensible Local Area Network (VXLAN), Network Virtualization using Generic Routing Encapsulation (NVGRE) and Network Virtualization Over layer 3 (NVO3) that may be standardized to support several million virtual networks (e.g. about 16 million virtual networks each). To connect to these several million networks, customers may connect through a Provider Edge (PE) device. The PE device may use virtual private network (VPN) labels to locate the associated virtual routing and forwarding (VRF) table entry for forwarding the customer's VPN packet. These VPN labels may be Multiprotocol Label Switching (MPLS) labels as described in Internet Engineering Task Force (IETF) Request for Comments 3032 (RFC 3032), which is incorporated herein by reference as if reproduced in its entirety.

The MPLS labels are represented as a label stack or sequence of label stack entries: a 20-bit Label Value indicating a forwarding address for a data packet, a 3-bit Experimental Use value, a 1-bit Bottom of Stack value indicating the last label in the MPLS label stack, and an 8-bit Time to Live value. However, the current MPLS label format which is widely used and accepted is only capable of supporting up to about one million of the labels used to uniquely address the numerous virtual networks in a data center. When, for example, a Border Gateway Protocol (BGP)/MPLS Internet Protocol (IP) VPN method is used by an enterprise or customer to access its corresponding virtual networks, more than one million labels (e.g. about 16 million labels) may be required to map the VPN labels to Virtual Network Identifiers. Unfortunately, the current 20-bit VPN labels may not be enough to map to all of the virtual network identification space.

### SUMMARY

In one embodiment, the disclosure includes a network element for forwarding a data packet to a virtual network. A table may be maintained comprising one-to-one mapping information between one or more VPN labels and one or more identifying labels for a destination virtual network. The network element may receive a data packet from a MPLS network. The data packet may comprise one or more VPN labels, at least one of which may be a MPLS Big Label Value that supports one-to-one mapping for more than one million destination virtual network addresses. The MPLS Big Label Value may comprise a destination virtual network address. The network element may map the one or more VPN labels to corresponding identifying labels for the destination virtual network according to the table, and forward the data packet to the destination virtual network.

In another embodiment, the disclosure includes a network element which receives a data packet in a VPN data path. The data packet may comprise a header and a payload. The header may comprise one or more VPN labels, and a first of the one or more VPN labels may support one-to-one mapping for more than one million virtual network addresses, and may contain a virtual network address. The network element may map the one or more VPN labels to one or more virtual networks according to a stored mapping table, and forward the data packet according to the one or more virtual network identifiers.

In yet another embodiment, the disclosure includes a network element which receives a data packet via a MPLS network. The network node may be configured to map a VPN address label to one of more than one million virtual network identifiers on a one-to-one mapping basis. The network node may also be configured to transmit the data packet to a virtual network indicated by the virtual network identifier.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a VPN.

FIG. 2 is a schematic diagram of an embodiment of a system where an embodiment of the present disclosure may operate.

FIG. 3 is a schematic diagram of an embodiment of a network element.

FIG. 4 is a diagram of one embodiment of a MPLS Big Label header.

FIG. 5 is a schematic diagram of another embodiment of a system where a data packet may be transmitted from a customer network to a data center.

FIG. 6 is a schematic diagram of another embodiment of a system where a data packet may be transmitted from a data center to a customer network.

FIG. 7 is a flowchart of a method of forwarding an MPLS data packet.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments that associate VPN labels used in a MPLS network with more than about one million addresses in a virtual network. Various embodiments of the present disclosure may be implemented according to IETF document draft-renwei-mpls-big-label-00.txt, draft-mpls-big-label-usecase-req-00.txt, and draft-renwei-13vpn-big-label-00.txt, which are incorporated herein by references as if reproduced in their entireties. In one embodiment, utilizing a Big Label header may provide one-to-one mapping of VPN data packets to virtual network addresses in VXLAN, NVGRE, and NVO3. A Big Label header may include a Big Label Value and be an extension to the RFC 3032 MPLS label format, such that the label space useable for indicating a virtual network address may be larger than the currently used 20-bit space, and the minimum number of supported labels may be increased to about 16 million. A Big Label header may extend the functionality of MPLS headers to support existing MPLS technology as well as provide for an increased number of VPN network addresses while maintaining backward compatibility and network equipment interoperability.

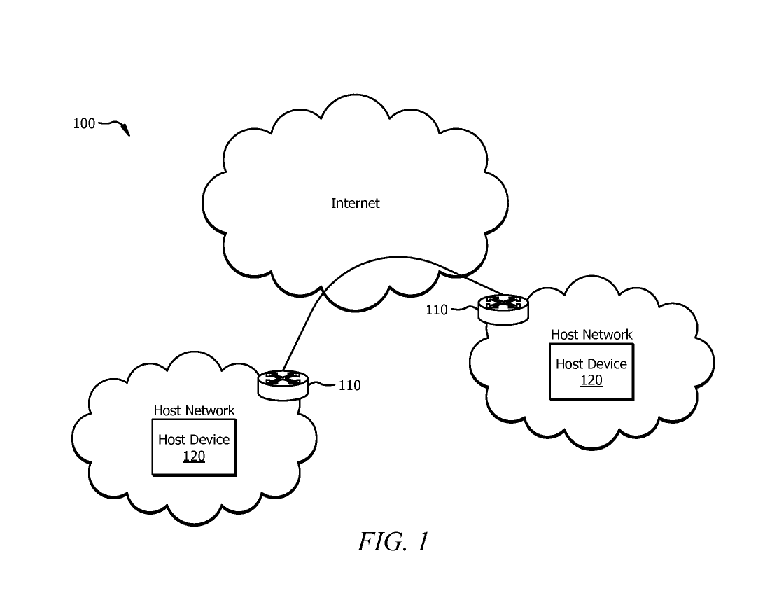

FIG. 1 is a schematic diagram of an embodiment of a VPN 100 where embodiments of the present disclosure may operate. The VPN 100 may comprise a plurality of host networks, each having an edge router 110 and a host device 120. The VPN 100 may allow one or more host devices 120 to connect to each other over a public network, e.g. the Internet, while operating as if the host devices 120 were connected directly together in a private network. As such, VPN 100 may allow host devices 120 to connect geographically diverse sites with data centers across core networks with high-performance and security. Edge router 110 may be any network element configured to receive and/or transmit data along one or more paths within the VPN 100. For example, edge router 110 may be a provider edge device, customer edge device, switch, router, bridge, and/or any other device that is used to forward data within the VPN 100. Edge router 110 may determine a VPN customer's prefix and VPN instance to determine the proper routing for a connection in VPN 100. Host devices 120 may be any network element configured to transmit, receive, originate, or terminate data, such as hosts, virtual machines, servers, clients, mobile communications devices, user-equipment, personal computing devices, and/or any other device capable of originating or terminating a VPN connection.

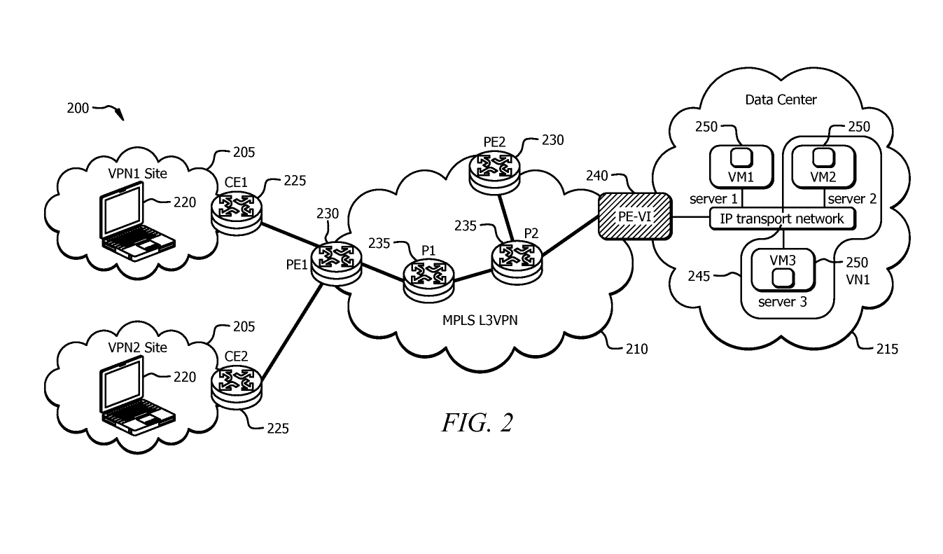

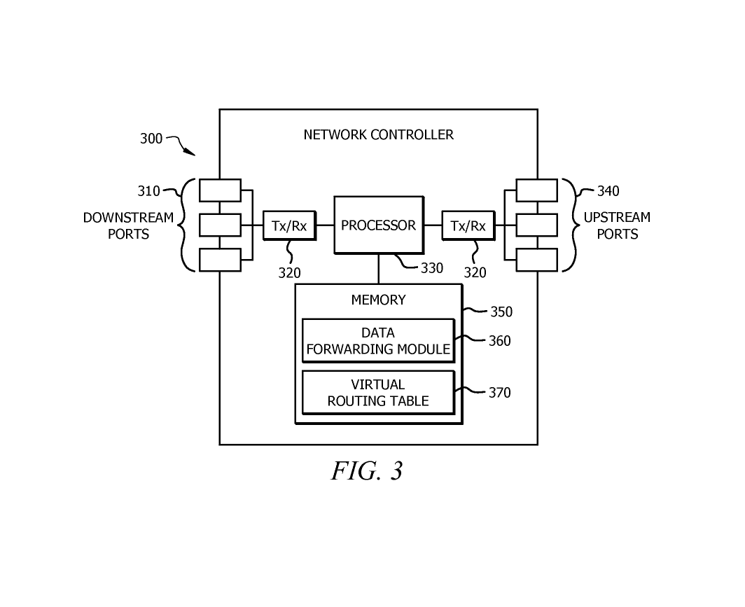

FIG. 2 is a schematic diagram of an embodiment of a system 200 where an embodiment of the present disclosure may operate. The system 200 may comprise one or more customer networks 205, a network 210 and a data center 215. Each customer network 205 may include a customer computing device 220 and a Customer Edge (CE) device 225. Customer computing device 220 may be any device that is capable of requesting a VPN connection (e.g. a client, a server, a user-equipment, a mobile communications device, personal computing device, etc.). CE device 225 may be any device that is coupled to one or more PE devices and is capable of transmitting and/or receiving data packets in a data path (e.g. an access point, an access point station, a router, a switch, a gateway, a bridge, etc.). Both customer computing device 220 and CE device 225 may be network elements, as described below in FIG. 3.

Network 210 may be an MPLS layer 3 (L3) VPN network that comprises one or more PE devices 230 coupled to one or more CE devices 225, one or more transit routers 235 coupled to the PE devices 230, and a PE-Virtual Interface (VI) 240. For exemplary purposes and for greater clarity, network 200 will be described using terminology customarily associated with VXLAN networks; however, it should be apparent to one of ordinary skill in the art that the following description applies generally to a plurality of network protocols (e.g. VXLAN, NVGRE, NVO3, etc.) and is not limited to a VXLAN implementation.

In some embodiments, network 210 may be referred to as a core network and/or a MPLS core. PE device 230 may use Border Gateway Protocol (BGP) to distribute VPN routes, maintain VRF tables, and may use MPLS to receive data packets from and/or forward packets to an MPLS network (e.g network 210). PE device 230, transit router 235, and PE-VI 240 may each be a network element as described below in FIG. 3. In some embodiments, PE-VI 240 may be a standard PE device such as PE device 230 coupled to a network virtualization edge (NVE) device, a VXLAN Virtual Tunnel End Point (VTEP), and/or any other device that provides CE functionality to a data center and/or maps data traffic from an incoming network to a virtual network. In these configurations, PE-VI 240 may be considered a gateway between network 210 and data center 215. For example, in a VXLAN network, PE-VI 240 may be a device with the combined functionality of a PE and a VXLAN-VTEP which originates and terminates VXLAN tunnels, runs necessary protocols to build and tear down VXLAN tunnels, and maintains VXLAN tunnel forwarding states, including a media access control (MAC) table.

Data center 215 may comprise one or more virtual networks 245, as well as one or more virtual machines 250. Each virtual network 245 and virtual machine may comprise a network element and/or may be implemented in a network element, as described below in FIG. 3. One or more virtual machines 250 may participate in one or more virtual networks 245. In some embodiments, data center 215 may utilize a VXLAN protocol for network overlay virtualization. In other embodiments, alternative protocols, such as NVGRE and NVO3, may be utilized for network overlay virtualization.

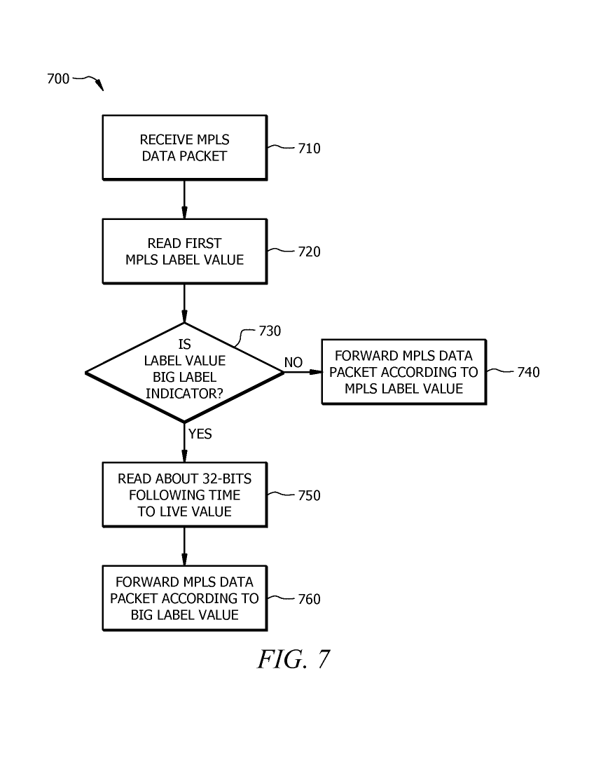

A customer computing device 220 may communicate with a virtual machine 250 via network 210. The customer computing device 220 may transmit a data packet to CE device 225 that may in turn forward the data packet to one or more PE devices 230. The PE devices 230 may insert an MPLS header between the data packet's layer 2 (L2) and layer 3 (L3) headers according to a destination and origination of the data packet. The MPLS header may comprise one or more MPLS label stack entries, each containing one or more labels. Each label stack entry may be used to provide next hop forwarding information for the data packet. The MPLS header may be an enhanced MPLS header, such that the MPLS header may support addressing for greater than about one million virtual networks. Alternatively, the MPLS header may have the capacity to support addressing for greater than about one million virtual networks but functions in a manner substantially similar to a 20-bit label value MPLS header without utilizing the additional capacity. PE device 230 may then transmit the data packet according to the MPLS header through one or more transit routers 235 until the data packet is received by a second PE device 230. The method of transmitting the data packet through network 210 may be substantially similar to method 700, described below in FIG. 7. Each PE device 230 and transit router 235 in a network 210 that utilizes an enhanced MPLS header, which has the capacity to support addressing for greater than about one million virtual networks, may support receiving, processing, and forwarding the enhanced MPLS header in order to distribute data traffic in network 210. Each PE device 230 and transit router 235 in a network 210 that supports the enhanced MPLS header may also support receiving, processing, and forwarding non-enhanced MPLS headers.

Once the data packet is received by the second PE device 230, the data packet may be forwarded to a CE device in data center 215, and then forwarded to the appropriate virtual network 245 and virtual machine 250. In some embodiments, the second PE device 230 and a VTEP for data center 215 may be replaced with a single PE-VI 240 device. The PE-VI 240 may serve as a gateway, receiving the data packet from a customer computing device 220 which has been transmitted through network 210 and forwarding the data packet to the virtual network 245 in data center 215, as specified by VXLAN information located in the MPLS header attached to the data packet. The PE-VI 240 may maintain one-to-one mapping information between L3VPN labels and VXLAN Network Identifiers (VNIs) to facilitate receiving data packets from network 210 and forwarding the data packets to data center 215, as well as receiving data packets from data center 215 and forwarding the data packets to network 210. In this embodiment, a data packet header being transmitted out of a PE toward an MPLS network may comprise about three layers: a label switched path (LSP) label, an L3VPN label, and a destination virtual machine IP address. At the PE-VTEP, the layers of the data packet may be mapped to VXLAN VNIs to form a data packet header being transmitted out of the PE-VTEP toward a VXLAN networked data center, and that comprises about three layers: an outer label, a VXLAN header or VNI, and an inner label.

In an alternative embodiment, data center 215 may utilize a NVGRE protocol for network overlay virtualization. In this embodiment, PE-VI 240 may instead be referred to as a PE-NVE. A PE-NVE may function substantially similar to a PE-VTEP, and may originate and terminate NVRE packets, maintain NVGRE Virtual Subnet Identifiers (VSIDs), and maintain one-to-one mapping information between L3VPN labels and NVGRE VSIDs. In this embodiment, a data packet header being transmitted out of a PE toward an MPLS network may comprise about three layers: a LSP label, an L3VPN label, and a destination virtual machine IP address. At the PE-NVE, the layers of the data packet may be mapped to NVGRE VSIDs to form a data packet header being transmitted out of the PE-NVE toward a NVGRE networked data center, and that comprises about three layers: an outer label, a NVGRE header or VSID, and an inner label.

In another embodiment, an L2VPN shared with one or more geographic areas outside of a single date center may be required (e.g. Ethernet-VPN, Q-in-Q, etc.). Virtual local area network (VLAN) Identifiers (VIDs) may be about 12-bit long fields that specify a VLAN to which a data frame belongs, and may allow up to about 4,096 VLAN instances. As an example and without imposing limitation, an enhanced MPLS header which has the capacity to support addressing for greater than about one million virtual networks may be used in a data center LAN extension which utilizes L2VPN over an MPLS core network. In this example, the data center may use Institute of Electrical and Electronics Engineers (IEEE) 802.1Q-in-Q VLAN Tag Termination for intranet, as described in IEEE standard IEEE 802.1Q-1998, which is incorporated herein by references as if reproduced in its entirety. With Q-in-Q may come an added layer of labeling known as a VLAN ID. In this example, a data packet header being transmitted out of a PE-VLAN toward an MPLS network may comprise about three layers: an outer label, a single layer combining an outer VLAN ID and an inner VLAN ID, and an inner label. Double tagged VLAN IDs, or a VLAN ID for an outer VLAN and a VLAN ID for an inner VLAN may require a minimum of an about 24-bit space, and may therefore require an enhanced MPLS header that has the capacity to support addressing for greater than about one million virtual networks. In yet another embodiment, an enhanced MPLS header, which has the capacity to support addressing for greater than about one million virtual networks, may be utilized to provide one-to-one mapping between VPN labels and NVO3 Virtual Network Identifier (VNIDs).

In yet another embodiment, an enhanced MPLS header, which has the capacity to support greater than about one million addresses, may be used to facilitate fast reroute protection in a maximally redundant trees multi-topology system. As an example and without imposing limitation, in a topology featuring about three trees, an MPLS label may be required to be globally unique in order to allow fast reroute. With an estimated 500,000 possible Internet routes per tree and three trees, about 1.5 million unique MPLS labels may be required to facilitate fast reroute, requiring an MPLS header capable of supporting greater than about one million addresses.

In yet another embodiment, an enhanced MPLS header which has the capacity to support greater than about one million addresses may be used to facilitate segment routing. A segment identification (SID) may require an about 32-bit long value to use for topological and/or service instructions. An MPLS header with at least an about 32-bit long address label space may properly support the about 4 billion possible segments in a routing domain.

At least some of the features/methods described in this disclosure may be implemented in a network element. For instance, the features/methods of this disclosure may be implemented using hardware, firmware, and/or software installed to run on hardware. The network element may be any device that transports data through a network, e.g., a switch, router, bridge, server, client, etc. FIG. 3 is a schematic diagram of an embodiment of a network element 300 that may be used to transport and process traffic through at least a portion of a VPN 100, shown in FIG. 1. At least some of the features/methods described in the disclosure may be implemented in a network element. For instance, the features/methods of the disclosure may be implemented in hardware, firmware, and/or software installed to run on the hardware. The network element 300 may be any device (e.g., an access point, an access point station, a router, a switch, a gateway, a bridge, a server, a client, a user-equipment, a mobile communications device, etc.) which transports data through a network, system, and/or domain. Moreover, the terms network “element,” network “node,” network “component,” network “module,” and/or similar terms may be interchangeably used to generally describe a network device and do not have a particular or special meaning unless otherwise specifically stated and/or claimed within the disclosure. In one embodiment, the network element 300 may be an apparatus configured to implement dynamic multi-destination addressing and/or to establish and communicate data traffic via a radio based connection (e.g., wirelessly). For example, network element 300 may be or incorporated within edge router 110 or a host device 120, shown in FIG. 1.

The network element 300 may comprise one or more downstream ports 310 coupled to a transceiver (Tx/Rx) 320, which may be transmitters, receivers, or combinations thereof. The Tx/Rx 320 may transmit and/or receive frames from other network nodes via the downstream ports 310. Similarly, the network element 300 may comprise another Tx/Rx 320 coupled to a plurality of upstream ports 340, wherein the Tx/Rx 320 may transmit and/or receive frames from other nodes via the upstream ports 340. The downstream ports 310 and/or the upstream ports 340 may include electrical and/or optical transmitting and/or receiving components. In another embodiment, the network element 300 may comprise one or more antennas coupled to the Tx/Rx 320. The Tx/Rx 320 may transmit and/or receive data (e.g., packets) from other network elements wirelessly via one or more antennas.

A processor 330 may be coupled to the Tx/Rx 320 and may be configured to process the frames and/or determine to which nodes to send (e.g., transmit) the packets. In an embodiment, the processor 330 may comprise one or more multi-core processors and/or memory modules 350, which may function as data stores, buffers, etc. The processor 330 may be implemented as a general processor or may be part of one or more application specific integrated circuits (ASICs), field-programmable gate arrays (FPGAs), and/or digital signal processors (DSPs). Although illustrated as a single processor, the processor 330 is not so limited and may comprise multiple processors. The processor 330 may be configured to communicate and/or process multi-destination frames.

FIG. 3 illustrates that a memory module 350 may be coupled to the processor 330 and may be a non-transitory medium configured to store various types of data. Memory module 350 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs which are loaded into the RAM when such programs are selected for execution. The ROM is used to store instructions and perhaps data that are read during program execution. The ROM is a non-volatile memory device which typically has a small memory capacity relative to the larger memory capacity of the secondary storage. The RAM is used to store volatile data and perhaps to store instructions. Access to both the ROM and RAM is typically faster than to the secondary storage.

The memory module 350 may be used to house the instructions for carrying out the various embodiments described herein. In one embodiment, the memory module 350 may comprise a data forwarding module 360 which may be implemented on the processor 330. In one embodiment, the data forwarding module 360 may be implemented to facilitate content forwarding and processing functions in an MPLS network coupled to one or more virtual networks, such as, an MPLS network coupled to one or more virtual networks via a PE-VI, such as PE-VI 240, shown in FIG. 2, which forwards received data from the MPLS network to the virtual networks according to an MPLS Big Label value and a mapping table. Such mapping information may be maintained in a virtual routing table 370 at the memory module 350. The data forwarding module 360 may read MPLS labels from received data, determine if the read MPLS labels indicate the presence of a MPLS Big Label, and if present, map the MPLS Big Label to virtual network addresses according to relationships and mapping information contained in virtual routing table 370. The data forwarding module 360 may then forward the received data to a next hop destination. The data forwarding module 360 may be implemented using software, hardware, or both and may operate above the IP layer, e.g., linking layer 2 (L2) or linking layer 3 (L3), in the OSI model.

It is understood that by programming and/or loading executable instructions onto the network element 300, at least one of the processor 330, the cache, and the long-term storage are changed, transforming the network element 300 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM, flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

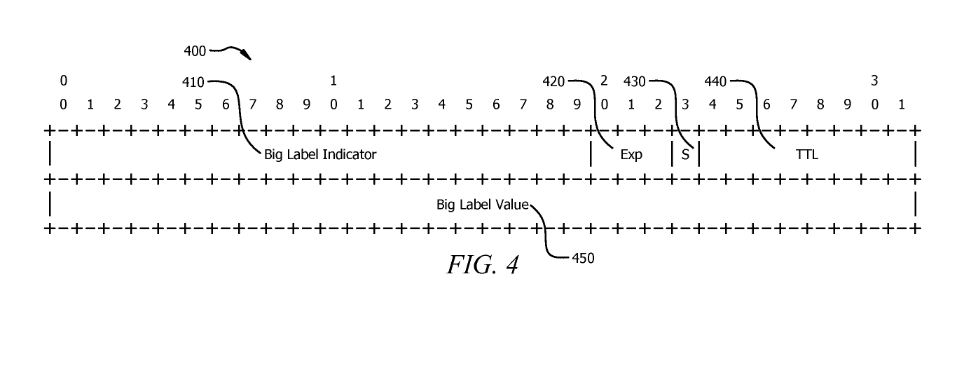

FIG. 4 is a diagram of one embodiment of a MPLS Big Label header 400. The MPLS Big Label header 400 may be attached to one or more data packet types, e.g. a data packet being transmitted from a course to a destination through an MPLS network, such as network 200, shown in FIG. 2. In some embodiments, the MPLS Big Label header 400 may facilitate the use of a greater number of virtual network address labels in VPN packet forwarding than are supported in the RFC 3032 MPLS label header. In some embodiments, MPLS header 400 may be an enhanced MPLS header which has the capacity to support greater than about one million addresses and/or an enhanced MPLS header which has the capacity to support addressing for greater than about one million virtual networks. The MPLS Big Label header 400, which may also be referred to as an MPLS Big Label stack, may comprise a plurality of about 32-bit long MPLS label stack entries, each containing one or more labels 410-450 of varying lengths. In MPLS Big Label header 400, these labels comprise a Big Label Indicator 410, an Experimental Use (Exp) value 420, a Bottom of Stack (S) indicator 430, a Time to Live (TTL) value 440, and a Big Label Value 450. Experimental Use value 420 may be about 3-bits long, Bottom of Stack indicator 430 may be about 1-bit long, and Time to Live may be about 8-bits long, all of which are defined in detail in RFC 3032.

In one embodiment, the Big Label Indicator 410 may be about a 20-bit long value comprising a reserved MPLS label selected from a reserved, unassigned range of 4-6 and 8-12. In this embodiment, Big Label Indicator 410 may be a value assigned by the Internet Assigned Numbers Authority (IANA). The use of a reserved IANA assigned value may facilitate backward compatibility between MPLS Big Label header 400 and non-Big Label MPLS label headers, thereby preserving the usefulness of existing network hardware. The use of a reserved IANA assigned value may also facilitate interoperability between network elements manufactured by a plurality of independent companies. In an alternative embodiment, Big Label Indicator 410 may be any value commonly known to network elements as a Big Label Indicator and is not limited to an IANA assigned or reserved value. In either embodiment, the presence of Big Label Indicator 410 may indicate to a network element, such as network element 300 of FIG. 3, that the received MPLS label header is an MPLS Big Label header 400 and the MPLS packet may be forwarded according to Big Label Value 450.

Big Label Value 450 may indicate a next hop over which the VPN packet is to be forwarded, as well as an operation to be performed on the VPN packet and other information which may be necessary in order to properly forward the VPN packet. In one embodiment, Big Label Value 450 may be about 32-bits long. In this embodiment, Big Label value 450 may be the about 32-bits that follow Time to Live value 440 in MPLS Big Label header 400. In another embodiment, Big Label Value 450 may be any length which contains a number of bits capable of uniquely representing a required number of virtual networks. In this embodiment, the first bit of Big Label Value 450 may follow the last bit of Time to Live Value 440. Alternatively, Time to Live Value 440 may be followed by a length indicator which is followed by Big Label Value 450. In this configuration, the length indicator may indicate a length of Big Label Value 450, thereby enabling Big Label Value 450 to be a length which provides a required number of virtual network addresses without requiring unnecessary data overhead in the MPLS Big Label header 400.

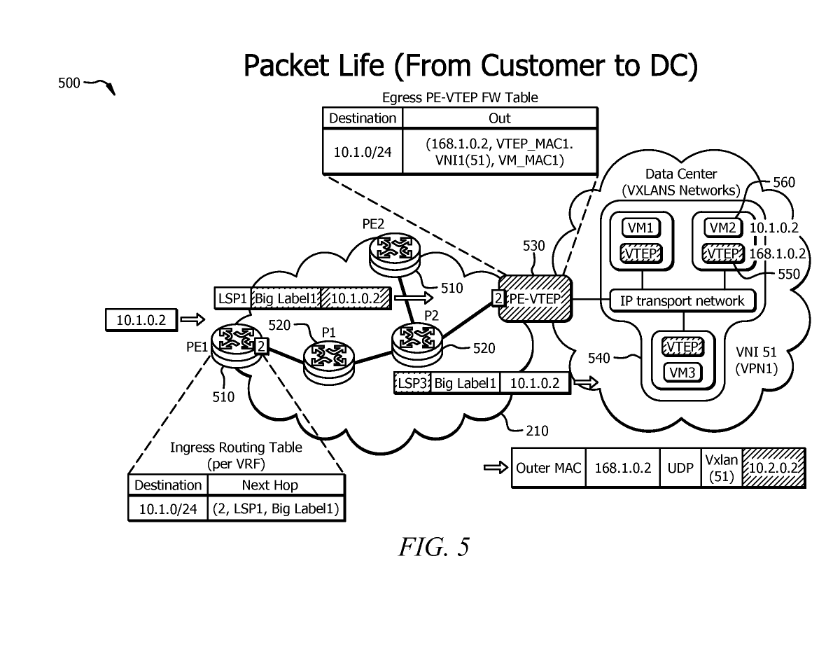

FIG. 5 is a schematic diagram of another embodiment of a system 500 where a data packet may be transmitted from a customer network to a data center. A PE device 510, which may be substantially similar to PE device 230, shown in FIG. 2, may receive a data packet in a BGP/MPLS based VPN which includes an address of a destination virtual machine 560 (e.g. an Internet Protocol address, such as 10.1.0.2). According to a stored VRF table, the PE device 510 may append MPLS LSP routing information and a MPLS Big Label header, which may be substantially similar to MPLS Big Label header 400, shown in FIG. 4, to the address of the destination virtual machine prior to forwarding the data packet to a next hop router in the MPLS VPN. Subsequent routers, such as transit routers 520, which may be substantially similar to transmit routers 235, shown in FIG. 2, may receive the data packet, and forward the data packet according to the appended MPLS LSP routing information until the data packet reaches a second PE device. The second PE device may be a standard PE device 510, or alternatively the PE device may be a PE-VTEP 530 which may have similar functionality to at least one of the embodiments of PE-VI 240, shown in FIG. 2.

The PE-VTEP 530 may, according to a stored VRF table, map the MPLS Big Label header to virtual network identifiers (e.g. VXLAN VNIs) prior to forwarding the data packet to a virtual network within a data center. The PE-VTEP 530 may replace the MPLS Big Label header with information such as an outer MAC address, and gateway address (e.g. next hop address) within the destination virtual network, a user datagram protocol (UDP) value, and a VXLAN VNI. The foregoing types of information serve only as examples and not limitations; the PE-VTEP may include more, less, or different information according to the requirements of the associated networks. Inside the data center, the data packet may be received by the appropriate virtual network 540, forwarded to the necessary VTEP gateway 550, and delivered to the destination virtual machine 560. Although the VXLAN protocol has been referred to in an exemplary manner above, the preceding steps and procedures may be equally applicable to a plurality of network protocols including, without limitation, VXLAN, NVGRE, NVO3, etc.

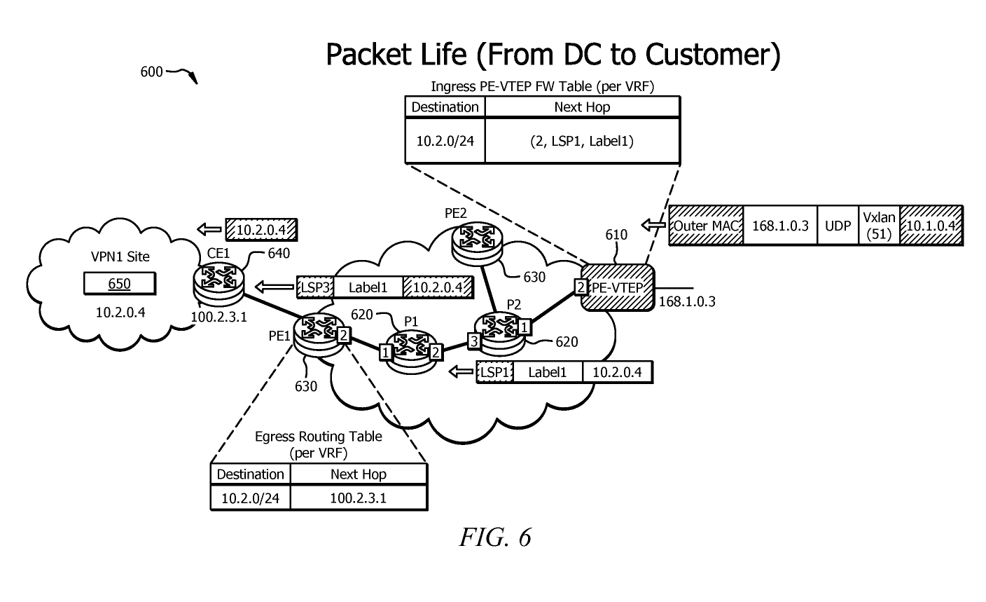

FIG. 6 is a schematic diagram of another embodiment of a system 600 where a data packet may be transmitted from a data center to a customer network. A PE-VTEP 610, which may be substantially similar to PE-VTEP 530, shown in FIG. 5, may receive a data packet from a virtual network that contains an outer MAC address, and gateway address (e.g. next hop address), UDP, VXLAN VNI for the network the data packet is coming from, and a destination IP address. The PE-VTEP 610 may map the received information to MPLS VPN labels according to a stored VRF table prior to forwarding the data packet to a next hop router in an MPLS VPN. The MPLS VPN labels may be standard RFC 3032 labels, or alternatively, the MPLS VPN labels may be Big Labels according to embodiments of the present disclosure. Subsequent routers, which may be transit routers 620, which may be substantially similar to transit routers 235, shown in FIG. 2, may receive the data packet, and forward the data packet according to the appended MPLS LSP routing information until the data packet reaches a PE device. The PE device 630 may determine a CE device next hop address for the data packet according to a stored VRF table, and forward the data packet accordingly to CE device 640. CE device 640 may receive the data packet and forward it to a customer computing device 650, which may be substantially similar to customer computing device 220, shown in FIG. 2, which has the attached destination IP address. Although the VXLAN protocol has been referred to in an exemplary manner above, the preceding steps and procedures may be equally applicable to a plurality of network protocols including without limitation, VXLAN, NVGRE, NVO3, etc.

FIG. 7 is a flowchart of a method 700 of forwarding an MPLS data packet. At step 710, a data packet with an MPLS header (e.g. MPLS Big Label header 400, shown in FIG. 4) is received by a MPLS label switch router (LSR), such as PE device 230 and/or transit router 235, shown in FIG. 2. At step 720 the MPLS LSR may read the first label value in the MPLS header. If the first label value is not a Big Label Indicator 410, shown in FIG. 4, at step 730 the MPLS LSR forwards the data packet according to the address indicated by the label read in step 720. If the first label value is a Big Label Indicator 410, show in FIG. 4, an indication is given to the MPLS LSR that the MPLS header is a MPLS Big Label header 400 and, at step 740, the about 32-bits following the Time to Live value 440 should be read for forwarding the MPLS data packet. At step 750, the MPLS data packet is forwarded to a next hop router (e.g. transit router 235, PE-VI 240, virtual network 245, and/or virtual machine 250, shown in FIG. 2) according to the Big Label Value 450 read by the MPLS LSR in step 740.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of forwarding a data packet to a virtual network comprising:
maintaining a table, wherein the table comprises one-to-one mapping information between one or more virtual private network (VPN) labels and one or more identifying labels for a destination virtual network;
receiving a data packet from a Multiprotocol Label Switching (MPLS) network, wherein the data packet comprises one or more VPN labels, wherein at least one of the one or more VPN labels comprises a MPLS Big Label Value, wherein the MPLS Big Label Value supports one-to-one mapping for more than one million destination virtual network addresses, and wherein the MPLS Big Label Value comprises a destination virtual network address;
mapping the one or more VPN labels to corresponding identifying labels for the destination virtual network according to the table; and
forwarding the data packet to the destination virtual network.

2. The method of claim 1, wherein the MPLS Big Label Value is about a 32-bit long value.

3. The method of claim 1, wherein the MPLS Big Label Value comprises a variable length value using at least a minimum number of bits necessary to represent the destination virtual network address.

4. The method of claim 1, wherein the method is implemented in a network element functioning as a provider edge (PE) network element to the MPLS network and a network virtualization edge (NVE) network element to the destination virtual network address.

5. The method of claim 4, wherein the network element is backward compatible to function with a 20-bit destination virtual network address.

6. The method of claim 1, wherein the one or more VPN labels further comprise a Big Label Indicator, and wherein the Big Label Indicator indicates to a network element that the data packet contains a MPLS Big Label Value.

7. A computer program product comprising computer executable instructions stored on a non-transitory computer readable medium such that when executed by a processor, cause the processor to:
receive a data packet in a Virtual Private Network (VPN) data path, wherein the data packet comprises a header and a payload, wherein the header comprises one or more VPN labels, and wherein a first of the one or more VPN labels supports one-to-one mapping for more than one million virtual network addresses, and wherein the first VPN label contains a virtual network address;
map the one or more VPN labels to one or more virtual network identifiers, wherein mapping the one or more VPN labels is performed based on a stored mapping table; and
forward the data packet according to the one or more virtual network identifiers.

8. The computer program product of claim 7, wherein the stored mapping table is a virtual routing and forwarding table (VRF).

9. The computer program product of claim 7 further comprising a Big Label Value, wherein the Big Label Value supports one-to-one mapping for up to about 4 billion virtual network addresses.

10. The computer program product of claim 9, wherein the Big Label Value supports one-to-one mapping for up to about 16 million virtual network addresses.

11. The computer program product of claim 7, wherein the virtual network identifier is a Virtual eXtensible Local Area Network (VXLAN) Network Identifier.

12. The computer program product of claim 7, wherein the virtual network identifier is a Network Virtualization using generic Routing Encapsulation (NVGRE) Virtual Subnet Identification.

13. The computer program product of claim 7, wherein the virtual network identifier is a Segment Routing Segment Identification.

14. The computer program product of claim 7, wherein the virtual network identifier is a Network Virtualization over Layer 3 (NVO3) Virtual Network Identification.

15. The computer program product of claim 7, wherein the virtual network identifier is a Virtual Local Area Network (VLAN) Identifier.

16. An apparatus comprising:
a receiver configured to receive a data packet via a Multiprotocol Label Switching (MPLS) network;
a processor coupled to a memory and the receiver, wherein the memory comprises computer executable instructions such that when executed by the processor causes the processor to map a Virtual Private Network (VPN) address label to one of more than one million virtual network identifiers on a one-to-one mapping basis; and
a transmitter coupled to the processor, wherein the transmitter is configured to transmit the data packet to a virtual network indicated by the virtual network identifier.

17. The apparatus of claim 16, wherein the apparatus has the combined function of a provider edge device for the MPLS network and a network virtualization edge for the virtual network.

18. The apparatus of claim 16, wherein the VPN address label is a 32-bit value.

19. The apparatus of claim 16, wherein the apparatus is compatible with 32-bit VPN address labels, and wherein the apparatus is compatible with non-32-bit VPN address labels.

20. The apparatus of claim 16, wherein the apparatus broadcasts its ability to receive, map, and transmit 32-bit VPN address labels in the MPLS network.
